(19) United States
(12) Patent Application Publication
(10) Pub. No.: US 2021/0353503 A1
(43) Pub. Date: Nov. 18, 2021

(54) A body intended for mounting to/on an outlet of a container with a fluid and a container delivering a medicine product or a dietary supplement in a solid form and a device comprising this body and this container

(71) Applicant: BIODEMADA SPOLKA Z O.O., Warszawa (PL)

(72) Inventors: Michal CHOJNACKI, Bydgoszcz (PL); Dariusz DANKOWSKI, Janikowo (PL); Emil KLUCZ, Znin (PL); Pawel ROSZCZYK, Warszawa (PL); Wiktor SROKA, Bydgoszcz (PL); Maja ZADLO, Torun (PL)

(21) Appl. No.: 17/279,785

(22) PCT Filed: Sep. 25, 2019
(86) PCT No.: PCT/IB2019/058114

§ 371 Date: Mar. 25, 2021

(30) Foreign Application Priority Data
Sep. 26, 2018 (PL) P.427187

(51) Int. Cl. A61J 7/00; A47G 19/22

(52) U.S. Cl. CPC A61J 7/0046; A47G 19/2205

(57) ABSTRACT

The invention relates to a body (4) intended for being mounted to/on an outlet of a container with a fluid, adapted for receiving a container (1) for administering a solid medicinal product or a dietary supplement together with a fluid. The invention further relates to the container (1) for administering a solid medicinal product or a dietary supplement together with a fluid, intended for being placed, at least partly, in the body (4) intended for being mounted to a container with a fluid. The invention further relates to a device for administering a solid medicinal product or a dietary supplement together with a fluid, comprising the body (4) for receiving the container (1), intended for being mounted on a container with a fluid, and the container (1) for administering a solid medicinal product or a dietary supplement together with a fluid.

In clinical practice there is frequently a need for oral administration of solid medicinal products or dietary supplements to individuals who require them. Unfortunately, such a pharmaceutical form poses significant problems related to taking it, resulting not only from disgust but frequently also from the health condition of an individual taking a medicinal product. For example, one in three people have a difficulty taking solid medicines and dietary supplements in the form of tablets, capsules, pills, dragées, granulate or powder.

Upon taking a solid medicine or a dietary supplement, the persons to whom they are administered may complain about retching, a feeling that a peel has become stuck or actually became stuck in the throat or a sense of fear of taking a medicine. Consequently, an individual requiring administration of a solid medicine or a dietary supplement may fail to take the recommended doses of a medicinal substance or auxiliary substances, which, consequently, may disturb the treatment or recovery process.

Importantly, problems with swallowing may not necessarily result only from a dislike of taking solid medicinal products or dietary supplements, that is, from psychological disorders, but what's more disturbing, from anatomy-related disorders or the general condition of an individual resulting from the adopted treatment or a pathological condition.

One of the most important issues related to taking solid medicinal products and dietary supplements having neurological and anatomical grounds is observed in persons who have been diagnosed with dysphagia, especially oesophageal dysphagia, that is, a disorder related to serious swallowing difficulties resulting from a disturbance in the passage of food into the oesophagus. Dysphagia most frequently occurs in geriatric persons, especially elderly persons. This results from occurrence in this group of many factors affecting the process of taking food, related to ageing. These factors include weight loss, decreased production of saliva or dehydration. Problems with dysphagia are also observed in persons suffering from neurological diseases or persons who have suffered a stroke. The problem becomes even more acute when an individual has to take more than one medicinal product, which is not a rare situation in this age group.

Another large group having problems with taking medicines is the paediatric group. Some of the said issues, such as fear of taking medicines, are more intense in the paediatric group than among individuals subjected to a treatment using solid medicines or dietary supplements, which may be related to a decreased awareness of the paediatric group of the necessity to take a specific medicinal product or dietary supplement. Additionally, significant factors determining the existence or lack of will to take medicinal products or dietary supplements in the paediatric group are the smell and taste of solid medicinal products or dietary supplements. Unfortunately, especially in the case of medicinal products approved for application in adults and children, it is frequently impossible to ensure positive olfactory-gustatory sensation when taking a product of this type. This factor has certainly a significant influence on the statistics resulting from the research published by Meltzer at al. (“Pill swallowing ability and training in children 6 to 11 years of age.” Clin Pediatr, Phila.; 45(8) in 2006, showing that approximately ⅓ of children have a problem with swallowing a pill. A research conducted by Kaplan et al. (“Successful treatment of pill-swallowing difficulties with head posture practice.” Paediatr Child Health, Oxford 2010; 15(5)) showed that swallowing pills is the main problem in the paediatric group as far as the problems with taking medicines are concerned.

It is also worth mentioning that medicinal products or dietary supplements which become stuck in the oesophagus or stick to its walls following their oral administration may cause irritation and inflammation of the oesophagus, resulting in pain and bleeding. Occurrence and exacerbation of these symptoms depends largely on the substance taken and its chemical properties. The more acidic or alkaline nature of a medicine dissolving slowly in the oesophagus or on its walls, the bigger the probability of a local irritation. In extreme cases the oesophagus may be perforated.

In the case of neurological and muscular disorders hampering taking solid medicinal products or dietary supplements, such a solid medicinal product or a dietary supplement may get into the respiratory tract of an individual taking it causing serious negative effects and posing a threat to the health or even life of such individual.

It is obvious that the group most exposed to the threat of solid medicinal products or dietary supplements getting stuck in their oesophagus is the geriatric group. However, within said group the most acute problems are observed in persons suffering from cardiology conditions. For example, left atrial hypertrophy may cause a significant pressure on the walls of the oesophagus thus increasing the probability of a pill becoming stuck therein.

An analysis of surveys conducted in the course of a research carried out by Bhosle et al. (“Difficult to swallow: patient preferences for alternative valproate pharmaceutical formulations” Patient Preference and Adherence 2009:3) shows that irrespective of the age and the health of the persons to whom solid medicinal products or dietary supplements are administered, the most important parameters encouraging a person to take a solid medicinal product or a dietary supplement orally or discouraging them from doing so is its size, hardness and type of coating. The preferred products are those which are relatively small (have a much smaller size than the internal diameter of the oesophagus of an individual to whom a product is to be administered) and coated such that they have a smooth surface. The research also showed that the final shape of a product (e.g. oval or round) does not significantly affect a person's will to take a solid medicinal product or a dietary supplement.

To facilitate taking a solid medicinal product or a dietary supplement, such products are administered to individuals requiring them together with a fluid. The known methods of facilitating administration of medicinal products or dietary supplement include washing them down or dissolving them in a container and administering them in a liquid form such as a solution, suspension or emulsion. However, not all solid medicinal products or dietary supplements are suitable for transforming them into a liquid form that is easier to take.

Administration of a solid medicinal product or a dietary supplement wherein it is not possible to provide its liquid substitute or transform it into a liquid form comes down to the necessity to take a solid medicinal product or a dietary supplement orally, followed by washing it down. The very taking of a solid medicinal product or a dietary supplement, even without swallowing it, is poses a problem to a significant group of individuals who may find it impossible to overcome. This problem is particularly important in the case of individuals who have a psychologically-driven disgust for taking solid products, especially solid medicinal products and dietary supplements. Even dissolving a solid product in a container with a fluid will not do in this case. Firstly, the entire fluid in a container contains a medicinal product or a dietary supplement transformed into a liquid form, hence the entire content of the container must be taken to keep the dose, which necessitates taking the entire volume of the fluid, which is frequently large due to poor solubility of a product, wherein, irrespective of the efforts made, after drinking the solution part of such a medicinal product or a dietary supplement in such a liquid form may remain on the walls of the container. Consequently, there is a lack of certainty as to the actual dose/amount of a medicinal product or a dietary supplement taken by an individual. It is possible to pour more fluid into the container to wash the remaining medicinal product or a dietary supplement out, however, this requires additional activities and gives no certainty as to whether or not the individual has taken the recommended amount/dose of the medicinal product or dietary supplement. Additionally, in the case of a psychologically-driven disgust transforming a solid medicinal product or a dietary supplement into a liquid form may, in some cases, fail to overcome the disgust to take a medicine or a dietary supplement.

Moreover, the very placement of a solid medicinal product or a dietary supplement in a container with a fluid may be problematic. This results from the fact that containers with a fluid intended for drinking have a shape of a bottle, and bottlenecks have a defined, relatively small diameter hampering administering a medicinal product or dietary supplement in the form of a powder or granules, especially to a geriatric patient, as part of such a medicinal product or a dietary supplement may be poured out of the bottle as a result of which an individual will take a smaller dose than originally prescribed.

Given the above problems, there is a need to provide a device which facilitate delivering a solid medicinal product or a dietary supplement to an individual requiring it, wherein such a device is easy to use, does not require transforming a solid form into a liquid one, does not require placing a solid medicinal product or a dietary supplement in a container and allows to control the dose taken by such an individual.

### PRIOR ART

There are known documents disclosing devices facilitating taking solid medicinal products or dietary supplements, however these technical solutions are not suitable for taking all solid forms such as tablets, capsules, pills, dragées, granulate, pellets and powder. Moreover, the solutions known from prior art require use of special containers or bottles adapted to a device, as they are not adapted to be used with the commonly available containers with a fluid such as all types of bottles, e.g. standard water bottles or bottles for feeding babies. Such solutions hamper administration of a solid medicinal product or a dietary supplement to an individual requiring it, especially wherein such need appears when a suitable container/bottle is not available.

### SUMMARY OF THE INVENTION

To eliminate the above-mentioned problems, a device according to the invention is provided.

The object of the invention is a body intended for mounting to/on an outlet of a container with a fluid, adapted for receiving the container for administering a solid medicinal product or a dietary supplement together with a fluid, wherein the body is longitudinal and contains a bottom, a circumferential side wall and a top surface, a chamber for placing therein the container for administering a medicinal product or a dietary supplement, wherein the bottom of the body comprises inflow means for providing inflow of a fluid from the container to the chamber, means equalizing the pressure in the container with the fluid, wherein the top surface comprises an opening for inserting therein the container for administering a medicinal product or a dietary supplement, wherein around the circumferential walls of the body there are arranged adapting means having a diameter greater than the diameter of the body for adapting the diameter of the body to the diameter of the outlet of the container with a fluid on which the body is mounted and a sealing of the connection between the body and the container with a fluid.

Owing to its design, the body according to the invention is usable with containers with a fluid, having a different internal diameter of the outlet, as a result of which it is universal. Owing to the adapting means, the diameter of the body increases upward, hence the portion of the body being placed into the outlet of the container with a liquid comprises a type of a cone, which wedges inside the outlet of the fluid container, providing a tight connection between the body and the container with a fluid. Consequently, the body according to the invention can be used with containers having a different internal diameter of the outlet of the fluid container, in particular, with standard PET bottles, in which water and soft drinks are sold. Hence, the need to provide a special container to which the body is mounted is eliminated.

Preferably, the body comprises a flange member arranged around the circumference of the body, in the vicinity of the top surface.

The flange member facilitates placing the body on the outlet of the container with a fluid. During placing the body on the outlet of the container, the user is able to grab the flange member for easier operation of the body. As the flange member has a diameter bigger than the body and the outlet of the container with a fluid, the flange member prevents unintentional placement of the body too deep inside the outlet of the container with a fluid or inside the container. Furthermore, the flange member facilitates removal of the body from the outlet of the container with a fluid as the user is able to remove the body by grabbing the flange.

Preferably, the flange member is arranged at the level of the top surface.

Arranging the flange member at the level of the top surface is easy in terms of production and facilitates maintaining the hygiene of the body when used multiple times as in such a case the flange member constitutes an extension of the top surface of the body, thus decreasing the number of folds on the surface of the body in which pollution may gather and bacteria may develop.

Preferably, the adapting means have the form of an annular member.

The adapting means in the form of an annular member have the broadest range of applications as majority of outlets of containers with a fluid are round. Moreover, annular members are the easiest to adapt.

Preferably, the adapting means have the form of two annular members, each having a different diameter, wherein the annular member having the smaller diameter is arranged closer to the bottom.

Application of two annular members allows using the body with a bigger number of containers, i.e. containers having different diameters.

Preferably, the body is provided with adapting means in the form of three annular members having a different diameter each, wherein the annular member having the smallest diameter is arranged the closest to the bottom, while each next annular member has a bigger diameter than the previous one.

Application of three annular members results in the body being even more preferable as it can be used with containers having different outlet diameters.

Preferably, the body comprises inflow means containing at least one opening for providing inflow of a fluid from the container and an element providing one-way flow of a fluid into the chamber.

The member providing one-way flow of a fluid from the container results in that after entering the chamber of the body the fluid does not return to the container on the outlet of which the body is mounted. Consequently, a fluid with a medicinal product or a dietary supplement does not enter into the container with a fluid. In result, the amount of the substance administered by an individual requiring it can be easily controlled while the fluid inside the container is not contaminated by the substance to be taken.

Preferably, the body comprises an element providing one-way flow of a fluid into the chamber, wherein the member providing the one-way flow to the chamber is an umbrella gasket.

The umbrella gasket is easy to install, what is particularly preferable, wherein the body is used as a multiple-use body, what allows efficient replacement of the gasket.

Preferably, the body has a cylindrical shape.

A cylindrical shape of the body is easy to manufacture and place in the outlet of the container with a fluid.

Preferably, the adapting means are inseparably attached to the body.

The adapting means inseparably attached to the body ensure a better tightness between the adapting means and the body; moreover, a potential change of position of the adapting means is eliminated that could occur during the installation of the body in the outlet of the container with a fluid or during the use of the container. Additionally, fixedly attached adapting means are arranged on the body in succession and relative to one another, what ensures their proper functioning, that is, in an ascending order toward the top, ensuring distances ensuring a tight fixing of the body by the adapting means in the outlet of the container with a fluid.

Alternatively, the adapting means are detachably attached to the body.

The adapting means detachably attached to the body result in a single body being even more universal as, for example, adapting means of a specific diameter can be used when the means that a given diameter of the outlet of the container requires are known. Moreover, the adapting means can be replaced with new ones when they become deformed after a certain number of applications.

A container supplying a solid medicinal product or a dietary supplement for taking together with a fluid, intended for being placed, at least partly, in the chamber of the body, wherein the container comprises a core for tight mounting thereof in the body of the chamber and comprises an inflow and an outflow, wherein the outflow is adapted for drinking through it, while the inflow is closed by means of a member permeable to a fluid and stopping a solid medicinal product or a dietary supplement, wherein the inside of the core is adapted for placing therein a solid medicinal product or a dietary supplement.

Owing to the container adapted for being tight mounted in the chamber of the body via the outlet of the container when the container is mounted to the body, an individual who requires it can suck the fluid in from a container with the fluid.

Preferably, the container comprises limiting means for limiting the extent of inserting the container into the chamber of the body.

The container is shaped relative to the chamber such that it can be inserted into the chamber of the body only to a specified depth, whereas use of limiting means in the form of additional elements may be an alternative to blocking the container in the chamber by means of adapting its shape or may constitute an additional protection against inserting the container too deep into the chamber.

Preferably, the limiting means are a protrusion on at least a portion of the external circumference of the core.

The limiting means in the form of the protrusion not only allow inserting the container into the chamber of the body only up to a specific depth and tighten the connection between the chamber of the body and the container.

Preferably, the body comprises mounting means for mounting the container to the body.

Additional mounting means is an additional protection against movement of the container relative to the body.

The element permeable to a fluid is arranged on the inflow of the core. Preferably, the container comprises an element allowing a fluid to pass through to the core, said element being placed at the end of the core on the outflow side.

A container containing at the end of the inflow an element allowing a fluid to pass through is simple to manufacture and easy to wash, when it is intended for multiple use.

Preferably, the container comprises an element allowing a fluid to pass through to the core, said element being placed inside the core on the inflow side.

A container comprising an element allowing a fluid to pass through to the inside of the core, that is, at a certain distance from the inflow, allows to apply a core end situated below the outlet as limiting means. Moreover, due to the fact that on the element allowing a fluid to pass through to the core a medicinal product or a dietary supplement is placed when said element is located above the inflow, after tilting the container during use a solid medicinal product or a dietary supplement falls into the oral cavity of an individual requiring it in within a shorter time. This is important as it reduces the time of taking a solid medicinal product or a dietary supplement, which is of particular importance in a group of individuals displaying a dislike for taking substances intended for consumption. Moreover, owing to this, the area of washing a substance intended for taking from the container is reduced and there is provided an easier insight into the substance intended for taking remaining in the container.

Preferably, the container comprises an element allowing a fluid to pass through to the core, said element being a membrane.

The membrane prevents a fluid from retreating toward the container with a fluid.

Preferably, the container comprises an element allowing a fluid to pass through to the core, said element being a polymer mesh.

Applying a mesh is cheap.

Preferably, the container has the diameter of the core of the container, which, on at least a portion of its length, increases toward the outflow.

Owing to the fact the diameter of the core increases toward the outflow, the inside of the core acts as a chute when an individual in need of a solid medicinal product or a dietary supplement tilts the container to take the solid medicinal product or the dietary supplement. Consequently, the solid medicinal product or the solid dietary supplement falls into the oral cavity of such an individual faster. Moreover, widening toward the outlet the core of the container facilitates pouring a substance into a solid medicinal product or a dietary supplement into the core in the process of manufacture of the container containing a solid medicinal product or a dietary supplement.

Preferably, the container contains a solid medicinal product or a dietary supplement for taking together with a fluid.

The container containing a solid medicinal product or a dietary supplement ensures sterility and certainty as to the amount/dose to be administered to an individual requiring it.

The present invention relates to a device for administering a solid medicinal product or a dietary substitute together with a fluid, comprising a body for receiving a container for administering a solid medicinal product or a dietary supplement together with a fluid, according to the invention, intended for mounting on a container with a fluid, and a container for administering a solid medicinal product or a dietary supplement together with a fluid, according to the invention.

The device according to the invention allows administering a solid medicinal product or a dietary supplement in an easy way, usable for use with different containers, including PET bottles, in which beverages and water are usually sold. Owing to the design of the device, a solid medicinal product or a dietary supplement does not get inside the container with a fluid. Moreover, the device provides the possibility to easily check the amount of a solid medicinal product or a dietary supplement taken.

Preferably, the device for administering a solid medicinal product or a dietary supplement with a fluid contains a member allowing one-way flow of the fluid into the chamber.

Owing to the design of the device, a solid medicinal product or a dietary supplement does not get inside the container with a fluid.

Preferably, the device for administering a solid medicinal product or a dietary supplement with a fluid contains a member ensuring one-way flow of the fluid into the chamber, wherein said member is an umbrella gasket.

An umbrella gasket prevents a fluid from retreating from the device into the container with a fluid. Moreover, an umbrella gasket used in the device does not produce any sound while using the device, what is important as sounds may constitute an additional factor discouraging from taking a solid medicinal product or a dietary supplement.

Preferably, the device for administering a solid medicinal product or a dietary supplement with a fluid contains a body permanently connected to the container.

Where the container is permanently connected to the body, using the container is even easier and the number of activities necessary to perform in order to use the device is smaller.

Preferably, the device for administering a solid medicinal product or a dietary supplement with a fluid contains a body detachably connected to the container.

Owing to the fact that the elements of the device are connected detachably, one of the elements can be used multiple times, e.g. the body together with the container, which can be of a single-use type. The body and the container can be either of a multiple use or single-use type.

Preferably, the device for administering a solid medicinal product or a dietary supplement with a fluid comprises a device for administering a medicine to an individual requiring it.

Preferably, the device for administering a solid medicinal product or a dietary supplement with a fluid comprises a device for administering a medicine to an individual requiring it, the individual selected from a paediatric group.

The device for administering a solid medicinal product or a dietary supplement with a fluid comprises a device for administering a medicine to an individual requiring it, the individual selected from a geriatric group.

Preferably, the device for administering a solid medicinal product or a dietary supplement with a fluid comprises a device for administering a medicine to an individual requiring it, the individual selected from a geriatric group having cardiology problems.

Research conducted on individuals having difficulty taking pills shows that using the device according to the invention significantly improves taking a solid medicinal product or a dietary supplement. The research covered 113 elderly persons belonging to a geriatric group, suffering from numerous disorders hampering taking solid substances. Each of the research participants declared to have problems with taking tablets, capsules, pills, pellets or even powder and granulate. To simulate taking a medicine said persons were administered a placebo in the form of a granulate containing sucrose. After completion of the research, each of its participants completed a survey determining the level of satisfaction from using the device, compared against taking of a solid medicine without the device. As many as 74.6% of the individuals participating in the research unequivocally stated that the device significantly facilitated taking a solid medicinal product or dietary supplement and that using the device was a better option than taking pills that they take daily without using the device. Based on this research a ratio has been prepared of the flow of a fluid through the entire system (size of particular components) to the level of satisfaction from the device. Furthermore, in the course of the research a model of adapting the level of the flow of a fluid through the device determining the further outflow of fluid to the needs of an individual to whom a solid medicinal product or a dietary supplement is administered.

### DESCRIPTION OF THE FIGURES

The body according to the invention, the container according to the invention, the device according to the invention for administering a solid medicinal product or a dietary supplement with a fluid are presented in the figures of the drawing, wherein:

FIG. 1 is an exploded view of the device for administering a solid medicinal product or a dietary supplement with together with a fluid, according to one of the embodiments of the present invention,

FIG. 2 is a cross-section of the body intended for mounting on the outlet of the container with a fluid, according to one of the embodiments of the present invention,

FIG. 3 is a perspective view of the body intended for mounting on the outlet of the container with a fluid, according to one of the embodiments of the present invention,

FIG. 4 is a cross-section of a kit for administering a solid medicinal product or a dietary supplement together with a fluid, arranged on the outlet of the container with a fluid, according to one of the embodiments of the present invention,

FIG. 5 is a cross-section of a kit for administering a solid medicinal product or a dietary supplement together with a fluid, arranged on the outlet of the container with a fluid, according to one of the embodiments of the present invention,

FIG. 6 is a cross-section of the device for administering a solid medicinal product or a dietary supplement together with a fluid, according to one of the embodiments of the present invention,

FIG. 7 is a cross-section of the container for administering a solid medicinal product or a dietary supplement together with a fluid, according to one of the embodiments of the present invention.

FIG. 8 is a cross-section of a container for administering a solid medicinal product or a dietary supplement together with a fluid, according to one of the embodiments of the present invention.

FIG. 9a to FIG. 9e are a side views of the body intended for mounting on the outlet of the container with a fluid, together with alternative embodiments of the adapting means,

FIG. 9a′ to FIG. 9e′ are cross-sections of the body intended for mounting on the outlet of the container with a fluid, together with alternative embodiments of the adapting means,

FIG. 10a to FIG. 10h are bottom views of the body intended for mounting on the outlet of the container with a fluid, together with alternative embodiments of the supply means.

### DETAILED DESCRIPTION OF THE INVENTION

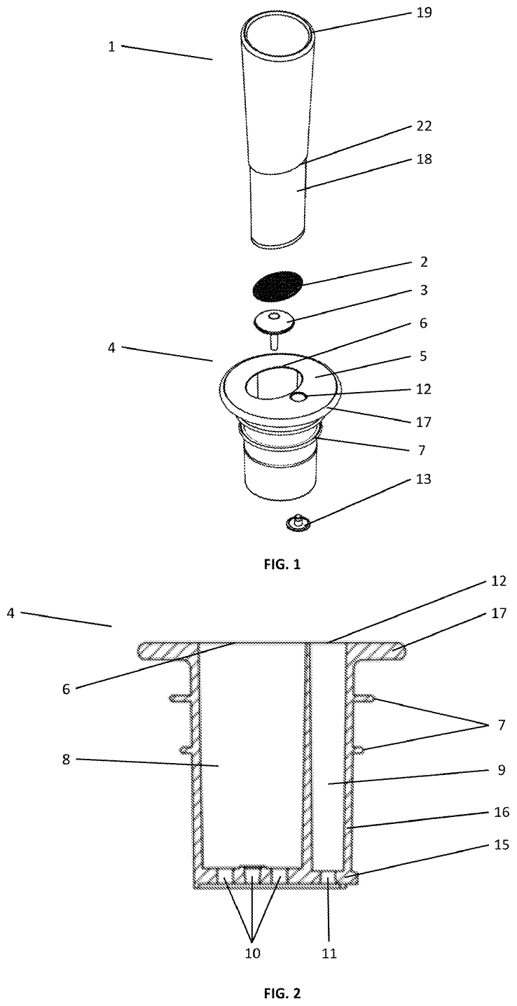

FIG. 1 shows an exploded view of a body 4 according to the invention and a container 1 according to the invention, forming together a device 26 according to the invention. Both the body 4 and the container 1 are shaped such that the container 1, whose portion is inserted into a chamber 8, is shaped such that it tightly fits the chamber 8 of the body 4. The body 4 has an elongated shape and contains a circumferential wall 16. The body 4 can have any shape allowing to fit the body 4 into an outlet 21 of the container with a fluid 14. The connection between the container 1 and the body 4 has to be tight and the respective shapes of the body 4 and the container 1 ensure tightness, however, it is possible to provide an additional sealing element, for example in the form of a gasket arranged on the external circumference of the container 1 in the vicinity of an opening 6 of the chamber 8 of the body 4. To ensure tightness and facilitate inserting the container 1 into the chamber 8, the chamber 8 narrows down toward a bottom 15, as illustrated in the figures showing cross-sections of the body 4. Where the chamber 8 narrows down toward the bottom 15, also the container 1 narrows down toward an inlet at least along the section which is inserted into the chamber 8.

Around the circumferential wall 16 of the body 4 there are arranged adapting means 7. The adapting means 7 have the form of annular members. In the embodiment shown in FIG. 2 and FIG. 3, around the circumferential wall 16 of the body 4 there are arranged adapting means 7 in the form of two rings.

In another embodiment, as shown in FIG. 4 to FIG. 6, around the circumferential wall 16 of the body 4 there are arranged adapting means 7 in the form of three rings. The number of the adapting means 7 is preferably two, more preferably three, more preferably four, five, six or more.

A bigger number of rings ensures matching a bigger number of outlets 21 of the container with a fluid 14. The adapting means 7 ensure tightness between the body 4 and the outlet 21 of the container with a fluid 14. The diameter of the adapting means 7 is bigger than that of the body 4. The adapting means 7 are arranged in a manner ensuring tightness between the body 4 and the outlet 21 of the container with a fluid 14. The annular elements are oriented parallel relative to each other.

The annular members are arranged relative to each other such that they form a cone. Hence, the adapting means 7 act as a wedge in the outlet 21 of the container with a fluid 14.

In an alternative embodiment (not shown) the adapting means 7 constitute in the form of a spiral oriented parallel to the circumference of the body. The adapting means 7 can be mounted permanently to the circumferential wall 16. In an alternative embodiment (not shown), the adapting means 7 can be mounted detachably in the outlet 21 of the container with a fluid 14. In such a case, the device 26 is formed by the body 4 according to the invention, the container 1 according to the invention and the adapting means 7 according to the invention. Above the adapting means 7 there is arranged a flange member 17. The flange member 17 is arranged around the circumference of the body 4, in the vicinity of a top surface 5. The flange member 17 is a depth limiter for limiting the depth of inserting the body 4 in the outlet 21 of the container with a fluid 14. The flange member 17 prevents inserting the body 4 into the outlet 21 of the container with a fluid 1 to deeply. Simultaneously, while removing the body 4 from the outlet 21 of the container with a fluid 14 the user grabs the flange member 17, what facilities removing the body 4 from the container with a fluid 14.

In the embodiment shown in FIG. 1 to FIG. 6 and FIG. 9, the flange member 17 of the body 4 is aligned with the top surface 5 of the body 4. Wherein the flange member 17 according to another embodiment can be formed by two protrusions anatomically matching the user (not shown). For example, the flange member 17 can have a shape adapted to the fingers of an individual. The flange member 17 according to the invention can have any shape facilitating removing the device 26 from the outlet 21 of the container with a fluid 14 following completion of administration of a solid medicinal product or a dietary supplement 27 together with a fluid to an individual requiring it.

The top surface 5 contains an inlet 12 of pressure equalising means 9. In an embodiment, the horizontal cross-section of the inlet 12 of the pressure equalising means 9 is oval. The inlet 12 of the pressure equalising means 9 can have any shape allowing proper functioning of the pressure equalising means.

The pressure equalising means 9 are arranged in any location on the body 4 that ensures proper functioning of the device 26. Preferably, the pressure equalising means 9 are arranged adjacent to the chamber 8. The pressure equalising means can, for example, be a chamber or a channel. The outlet 11 of the pressure equalising means is shown in FIG. 2 and FIG. 3. The outlet 11 of the pressure equalising means comprises a pressure equalising gasket 13.

The top surface 5 in the vicinity of the inlet 12 of the pressure equalising means 9 comprises an opening 6 for entering therein the container 1 for administering a solid medicinal product or a dietary supplement. Wherein the inlet 12 of the pressure equalising means is adjacent to the opening 6 for inserting therein the container 1 delivering a solid medicinal product or a dietary supplement 27.

The container is inserted into the chamber 8 of the body 4 through the opening 6 for inserting therein the container 1 for administering a solid medicinal product or a dietary supplement 27. The shape of the opening 6 is adapted to the shape of the container 1. In the presented figures of the embodiments of the invention the opening 6 is oval. The oval shape of the horizontal section of the opening 6 for inserting therein the container 1 for administering a solid medicinal product or a dietary supplement 27 results from the fact that the container 1 for administering a solid medicinal product or a dietary supplement 27 is inserted into the opening 6. Wherein the shape of the cross-section of the opening 6 for inserting therein the container 1 for administering a solid medicinal product or a dietary supplement 27 is adapted to the container 1. The cross-section of the opening 6 for inserting therein the container 1 for administering a solid medicinal product or a dietary supplement 27 can have any shape allowing proper matching of the opening 6 of the body 4 and the container 1, while ensuring proper functioning of the device 26.

The container 1 for administering a solid medicinal product or a dietary supplement 27 together with a fluid comprises a core 18 comprising an outflow 19 and an inflow 20. Preferably, the circumferential wall of the core 18 comprises mounting means 23. Preferably, the mounting means 23 have a hooked shape. The hooked shape of the mounting means 23 can be realized in the form of a catch. Wherein the mounting means 23 allow proper arrangement of the container 1 relative to the body 4, which is of particular importance in the case of containers having a diameter other than round. The limiting means 22 limit the depth to which the container 1 can be inserted into the chamber 8 of the body 4, as the container 1 can be inserted into the chamber 8 up to such a depth in order not to block nor hamper the operation of the inflow means 10. Preferably, the limiting means 22 are in the form of a protrusion, as shown in the attached figures. The limiting means 22 can be a protrusion around the entire circumference of the core 18; as the limiting means 22 can also have the form of a protrusion or protrusions on at least a portion of the circumference of the core 18 of the container 1. The outlet 20 is closed by means of the element 2 which transmits a fluid into the core 18 and stops a solid medicinal product or a dietary supplement 27 situated inside the core 18. Wherein the element 2 which is permeable to a fluid through and stops a solid medicinal product or a dietary supplement 27 is, for example, a membrane. Preferably, the membrane of the element 2 is made of polymer.

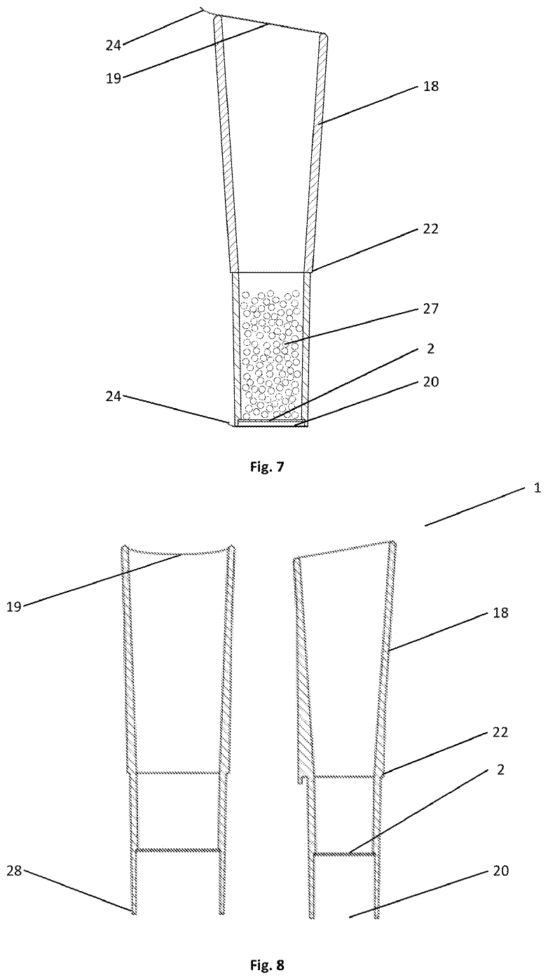

Preferably, the membrane of the element 2 which is permeable to a fluid and stops a solid medicinal product or a dietary supplement 27 is made of a hydrophobic material. Wherein the element 2 permeable to a fluid and stoppable to a solid medicinal product or a dietary supplement 27 is permanently connected to the container 1 for administering a solid medicinal product or a dietary supplement 27 together with a fluid. In the embodiment shown in FIG. 4 to FIG. 7, the element 2 closes the inflow 20 such that the element 2 is arranged at the bottom of the core 18. In the embodiment shown in FIG. 8, the element 2 closes the inflow 20 such that the element 2 is arranged at a distance from the edge 28 of the inflow 20. In this embodiment the tip of the core 18 arranged below the element 2 can comprise the limiting means 22. In such a case, the lower edge 28 of the core 18 is inserted such that it contacts the bottom 15, but the diameter of the lower edge 28 and of the core 18 has to be such as not to disturb, hamper nor limit the operation of the inflow means 10.

The device 26 can form a single component comprising permanently connected a body 4 according to the invention, and a container 1 according to the invention. The device 26 comprises two components, a body 4 according to the invention and a container 1 according to the invention. When the adapting means 7 are detachably connected to the body 4, the device 26 comprises three components, a body 4 according to the invention, a container 1 according to the invention, and the adapting means 7. The body 4 according to the invention can be a single use or a multiple use component. Wherein the container 1 according to the invention can be a single use or a multiple use component.

FIG. 2 shows a cross-section of the body 4 according to the invention. The body 4 according to the invention has a circular cross-section. A cross-section is understood to mean a section of the container 1 made when the container is oriented vertically, that is, when it is standing on its bottom. The body 4 comprises a chamber 8 and pressure equalising means 9. The body 4 comprises a bottom 15. The bottom 15 of the chamber 8 comprises inflow means 10. The bottom 15 of the body 4 of the pressure equalising means 9 comprises an outlet 11 of the pressure equalising means. Wherein the pressure equalising means 9 ensure pressure equalisation allowing water to freely flow out of the container with a fluid 14 via the inflow 20 of the core 18. In the embodiment shown in FIG. 2, there are shown the adapting means 7 in the form of annular members. The annular members of the adapting means have different diameters, wherein the annular member having a smaller diameter is arranged closer to the bottom of the body 15. Wherein the increasing dimensions of the annular members provides a tight fit in the outlet 21 of the container with a fluid 14. To ensure a tight connection between the container with a fluid 15 and the body 4, at least one annular element is in tight contact with the outlet 21 of the container with a fluid 14.

FIG. 3 shows a perspective view of the body 4 with visible bottom 15. The bottom 15 of the body 4 comprises inflow means 10. In the embodiment shown in FIG. 3 there are shown the inflow means 10 in the form of three openings. The inflow means 10 comprise a mounting slot 25 of the umbrella gasket 3. Preferably, the openings of the inflow means 10 are shaped like an ellipse, preferably as a kidney. It is clear that the inflow means 10 have any shape allowing proper flow of a fluid from the container 14, and proper functioning of the umbrella gasket. Preferably, the inflow means 10 comprise an umbrella gasket 3 shaped like an upward-facing umbrella. The umbrella gasket 3 can be any gasket ensuring one-way flow of water from the container 14 into the inflow 20 of the core 18. Preferably, the umbrella gasket 3 prevents a fluid from receding together with a diluted solid medicinal product or a dietary supplement 27.

In the embodiment shown in Fig., there are shown the adapting means 7 in the form two of annular members. The annular members of the adapting means 7 have different diameters. The annular member having a smaller diameter is arranged closer to the bottom 15 of the body 4. Above the adapting means 7 there is arranged a flange member 17. The flange member 17 is arrange on a level with the top surface 5.

FIG. 4 shows a cross-section of the body 4 according to the invention and of the container 1 according to the invention, together forming the device 26 according to the invention, arranged in the outlet 21 of the container with a fluid 14. The body 4 is mounted in the outlet 21 of the container with a fluid 14.

The pressure equalising means 9 comprise a pressure equalising gasket 13.

Preferably, the pressure equalising gasket 13 is shaped like a downward-facing umbrella. The pressure equalising gasket 13 ensures flow of air to the bottle when the pressure in the bottle changes as a result of a fluid being sucked out of the container with a fluid. However, it is clear that the pressure equalising gasket 13 can be any gasket ensuring equalisation of pressure and preventing a fluid from flowing through the outlet 11 of the pressure equalising means. Preferably, following tilting the container with a fluid 14 by an individual requiring it, the pressure equalising gasket 13 of the body 4 of the device 26 ensures outflow of the fluid through the inflow means 10.

In the embodiment shown in FIG. 4 there are shown the adapting means 7 in the form of three annular members. The annular members of the adapting means 7 have different diameters. The annular member having the smallest diameter is arranged closest to the bottom 15 of the body 4. The annular member having the biggest diameter is arranged closest to the top surface 5 of the body 4. The annular member having an intermediate diameter is arranged between the annular member having the smallest diameter and the annular member having the biggest diameter.

The annular member having the biggest diameter is arranged on the upper edge of the outlet 21 of the container with a fluid 14. Above the adapting means 7 there is arranged a flange member 17. The flange member 17 is arranged at a level with the top surface 5. In the chamber 8 there is inserted the container 1 for administering a solid medicinal product or a dietary supplement 27.

The container 1 for administering a solid medicinal product or a dietary supplement 27 comprises a core 18 comprising an outflow 19 and an inflow 20, wherein the inflow 20 is closed by means of an element 2 allowing a fluid to enter the core 18. The inflow 20 of the container 1 for administering a solid medicinal product or a dietary supplement 27 together with a fluid has a smaller diameter than the outflow 19 of the container 1. Wherein the difference between the diameter of the inflow 20 of the container 1 and that of the outflow 19 of the container 1 forms a chute providing the most optimal shape for administering a solid medicinal product or a dietary supplement 27 together with a fluid. Wherein the difference between the diameter of the inflow 20 of the container 1 and that of the outflow 19 of the container 1 forms a chute which facilitates pouring, dumping, sliding or washing out a solid medicinal product or a dietary supplement 27 from the container 1. Preferably, the outflow 19 of the container 1 is cut at an angle, what additionally makes it easier for an individual requiring it to pour, dump, slide or wash out a solid medicinal product or a dietary supplement 27 from the container 1 into the oral cavity of said individual requiring it.

Preferably, the inside of the core 18 is covered with a material or a coating reducing its electrostatic properties, which ensures the most optimal administration of a solid medicinal product or a dietary supplement 27 together with a fluid to an individual requiring it. The cross-section of the inflow 20 of the container 1 for administering a solid medicinal product or a dietary supplement 27 together with a fluid has an elliptical shape. The outflow 19 of the container 1 for administering a solid medicinal product or a dietary supplement 27 together with a fluid may have any shape, preferably that of a circle, most preferably, that of an ellipse. An elliptical shape is the most advantageous one as it ensures free administration of a solid medicinal product or a dietary supplement 27 together with a fluid. The cross-section of the outflow 19 of the container 1 for administering a solid medicinal product or a dietary supplement 27 together with a fluid has an elliptical shape. The outflow of the container 1 for administering a solid medicinal product or a dietary supplement 27 together with a fluid may have any shape, preferably that of a circle, most preferably that of an ellipse. Wherein the most advantageous shape is that of an ellipse, being the most optimal shape for administering a solid medicinal product or a dietary supplement 27 together with a fluid.

Preferably, the outflow 19 can end with a mouthpiece facilitating administration of a solid medicinal product or a dietary supplement 27 to an individual requiring it. In the embodiment of the invention, as shown in FIG. 4, the core 18 of the container 1 for administering a solid medicinal product or a dietary supplement 27 comprises limiting means 22 and mounting means 23.

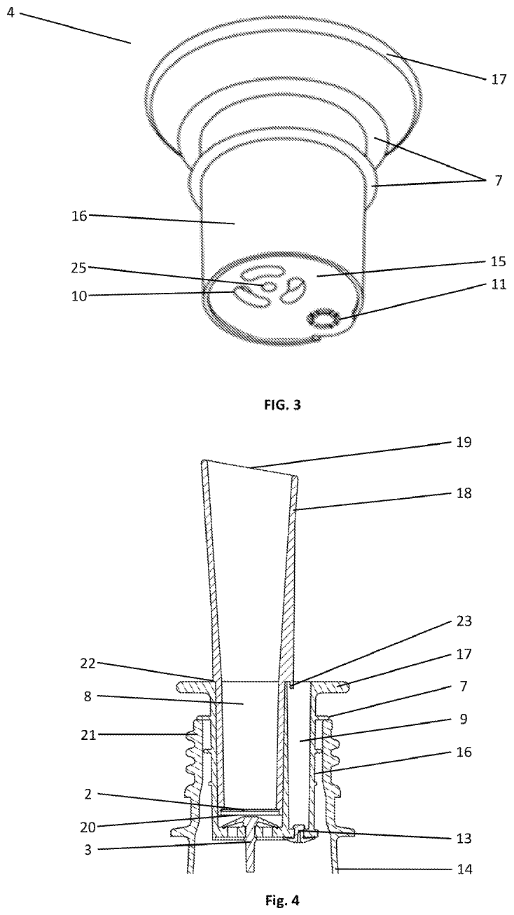

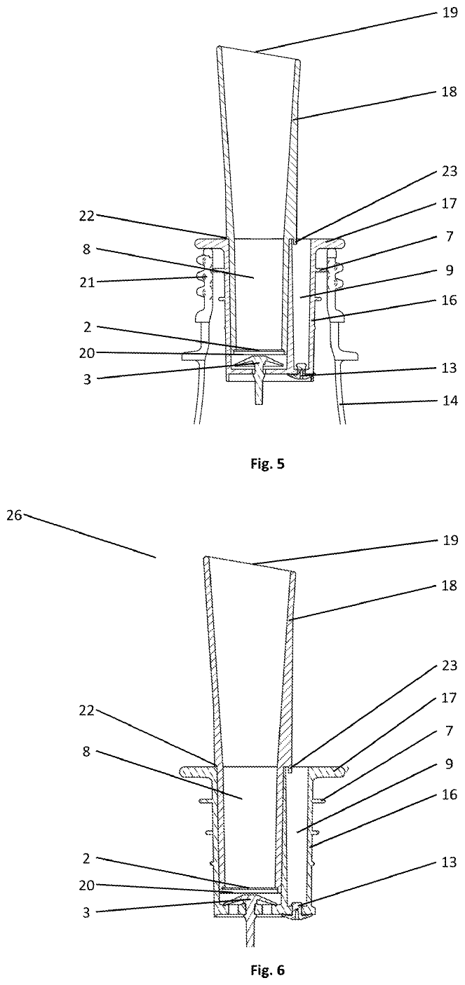

FIG. 5 shows a cross-section of the body 4 according to the invention and of the container 1 according to the invention, together forming the device 26 according to the invention, arranged in the outlet 21 of the container with a fluid 14. Wherein in FIG. 5 the outlet 21 of the container with a fluid 14 has a bigger diameter than the outlet 21 of the container with a fluid 14 shown in FIG. 4. Increasing toward the top, the diameter of the adapting means 7 causes the body 4 to block in the outlet 21 of the container with a fluid 14 at the level of the adapting means 7, whose diameter prevents the body 4 from moving further into the outlet 21 of the container with a fluid 14.

Wherein the level at which the body 4 stops depends on the diameter or diameters of the adapting means 7. In this embodiment of the invention, as shown in FIG. 5, the diameter of the adapting means 7 mounted closest to the top surface 5 is bigger than the diameter of the outlet 21 of the container with a fluid 14. FIG. 6 presents a cross-section of the body 4 according to the invention and of the container 1 according to the invention, together forming the device 26 according to the invention.

FIG. 7 presents a cross-section of the container 1 according to the invention. The container 1 for administering a solid medicinal product or a dietary supplement together with a fluid comprises a core 18 having an outflow 19 and an inflow 20. On the circumferential wall of the core 18 there are located mounting means 23. The inflow 20 is closed by means of the element 2 allowing a fluid to flow into the core 18. The element 2 permeable to a fluid and stoppable to a solid medicinal product or a dietary supplement 27, and the outflow 19 of the core 18 are closed by means of protection means 24. Preferably, the protection means 24 are an aluminium foil. Inside the container 1 for administering a solid medicinal product or a dietary supplement 27 together with a fluid there is a solid medicinal product or a dietary supplement. Preferably, the solid medicinal product or a dietary supplement 27 is a solid medicine in different forms. Said different forms of a solid medicinal product or a dietary supplement 27 include tablets, capsules, pills, dragées, granulate and pellets.

FIG. 8 shows a cross-section of the container 1 according to the invention. The container 1 for administering a solid medicinal product or a dietary supplement together with a fluid comprises a core 18 having an outflow 19 and an inflow 20. In the embodiment shown in FIG. 8, the core 18 of the container 1 for administering a solid medicinal product or a dietary supplement 27 comprises the limiting means 22. The inflow 20 is closed by means of the element 2 permeable to a fluid and stoppable to a solid medicinal product or a dietary supplement 27 inside the core 18. Wherein the element 2 permeable to a fluid and stoppable to a solid medicinal product or a dietary supplement 27 is mounted inside the core 18 at a distance allowing proper operation of the inflow means 10.

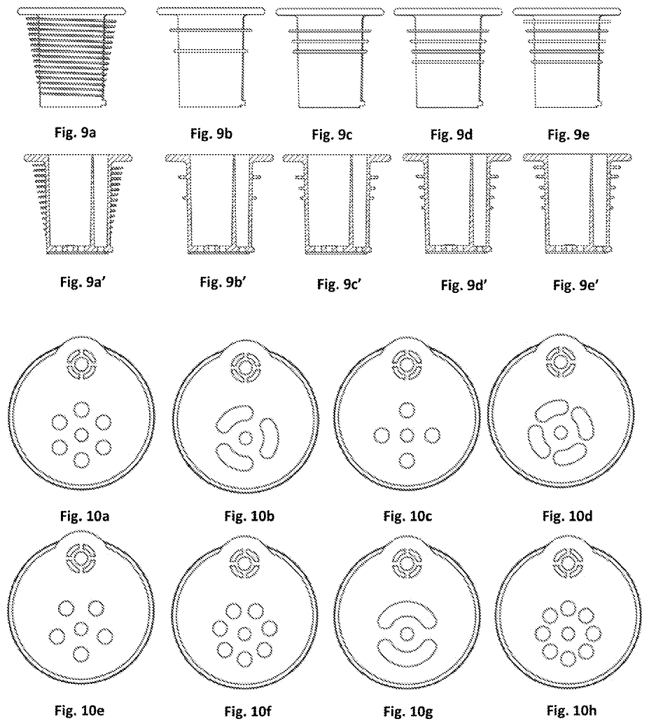

FIG. 9a to FIG. 9e and FIG. 9a′ to FIG. 9e′ show side views and cross-sections, respectively, of the body 4 with alternative embodiments of the adapting means 7. FIG. 9a and FIG. 9a′ show a side view and a cross-section, respectively, of the body 4 with the adapting means 7 in the form of a dense spiral oriented parallel to the diameter of the body. FIG. 9b and FIG. 9b′ show a side view and a cross-section, respectively, of the body 4 with the adapting means 7 in the form of two annular members. FIG. 9b and FIG. 9c′ show a side view and a cross-section, respectively, of the body 4 with the adapting means 7 in the form of three annular members. FIG. 9d and FIG. 9d′ show a side view and a cross-section, respectively, of the body 4 with the adapting means 7 in the form of four annular members. FIG. 9e and FIG. 9e′ show a side view and a cross-section, respectively, of the body 4 with the adapting means 7 in the form of five annular members.

FIG. 10a to FIG. 10h show views of the body 4 from the bottom, together with alternative embodiments of the inflow means 10. FIG. 10a show a view from the bottom of the body 4, together with the inflow means 10 in the form of six round openings arranged evenly around the mounting opening 25. FIG. 10b shows a view from the bottom of the body 4, together with the inflow means 10 in the form of three openings shaped like a kidney, arranged evenly around the mounting opening 25. FIG. 10c shows a view from the bottom of the body 4, together with the inflow means 10 in the form of four round openings arranged evenly around the mounting opening 25. FIG. 10d shows a view from the bottom of the body 4, together with the inflow means 10 in the form of four openings shaped like a kidney, arranged evenly around the mounting opening 25. FIG. 10e shows a view from the bottom of the body 4, together with the inflow means 10 in the form of five round openings arranged evenly around the mounting opening 25. FIG. 10f shows a view from the bottom of the body 4, together with the inflow means 10 in the form seven round openings arranged evenly around the mounting opening 25. FIG. 10g shows a view from the bottom of the body 4, together with the inflow means 10 in the form of two openings shaped like a kidney, arranged evenly around the mounting opening 25. FIG. 10h shows a view from the bottom of the body 4, together with the inflow means 10 in the form of eight round openings arranged evenly around the mounting opening 25.

In this embodiment, the umbrella gasket 3 has a diameter smaller than that of the core 18, what ensures proper operation of the device 26.

The container 1 for administering a solid medicinal product or a dietary supplement 27 together with a fluid, intended to be placed, at least partly, in the body 4 for mounting to the container with a fluid 14, the container 1 comprises a core 18 having an inflow 20 and an outflow 19, wherein the outflow 19 is provided in the form of a mouthpiece which is widened in order to facilitate the pouring of a solid medicinal product or a dietary supplement 27 and to prevent the jamming of a solid medicinal product or a dietary supplement 27 inside the core 18 of the container 1. The inside of the core 18 is adapted for placing therein a solid medicinal product or a dietary supplement 27, the inlet 20 is closed by means of the element 2 permeable to a fluid, which is intended to prevent a solid medicinal product or a dietary supplement 27 from entering the chamber 8 of the body 4, while allowing a fluid to flow from the container with a fluid 14 through the element 2. The container 1 is push-fitted in the chamber 8 of the body 4. However, to ensure proper operation of the inflow means 10, the limiting means 22 are provided for limiting the depth of entering the container 1 into the chamber 8 of the body 4. Additionally, the widened outlet 19 facilitates pouring a solid medicinal product or a dietary supplement 27 into the container 1 by an individual requiring it, where the container 1 is a multiple-use container 1.

The container 1 shown in FIG. 7, provided as a finished product, is protected on the side of the inflow 20 and the outflow 19 of the container 1 with the protection means 24. The protection means 24 protect against spilling of a solid medicinal product or a dietary supplement 27 out of the container 1 and ensure sterile closing of the container 1, while a solid medicinal product or a dietary supplement 27 for taking together with a fluid is inside the core 18 of the container 1.

The container 1 shown in FIG. 7, according to one embodiment, is provided as a single-use container 1. The single-use container 1, following administration of a solid medicinal product or a dietary supplement 27 placed inside the core 18 of the container 1, should be disposed off.

The container 1 presented in FIG. 7, according to another embodiment, is provided as a multiple-use container 1. The multiple-use container 1, following administration of a solid medicinal product or a dietary supplement 27 placed inside the core 18 of the container 1 can be washed and then refilled by pouring into the container 1 another, proper solid medicinal product or a dietary supplement 27.

When an individual requiring it intends to use the device 26, in the first stage the protection means 24 should be removed from the inlet 20 and the outlet 19 in order to release the inlet 20 and the outlet 19 of the container 1.

In the next stage, the body 4 is mounted on the outlet 21 of the container with a fluid 14 and, subsequently, the container 1 is inserted into the chamber 8 of the body 4. It is also possible to insert the container 1 into the chamber 8 of the body 4 in the first stage, and then place the device 26 in the outlet of the container with a fluid 14. The container with a fluid 14 is, for example, a PET bottle or another container with a fluid. The mounting of the body 4 on the outlet 21 of the container with a fluid 14 is realized by means of the adapting means 7 having a diameter bigger than that of the body 4, made from a flexible material, arranged around the circumferential wall 16 of the body 4, below the flange member 17. The adapting means 7 adapt the diameter of the body 4 to that of the outlet 21 of the container with a fluid 14, onto which the body 4 is mounted. The adapting means 7 provide a tight connection between the body 4 and the container with a fluid 14 in order to prevent an outflow of the fluid from the container with a fluid 14 between the body 4 and outlet 21 of the container with a fluid 14. The necessity to use the adapting means 7 adapting the diameter of the body 4 to that of the outlet 21 of the container with a fluid 14 results from the different diameters of the outlets 21 of the containers with a fluid 14 available on the market. The adapting means 7 are made of a flexible material; consequently, during mounting of the body 4 in the outlet 21 of the container with a fluid 14, the adapting means 7 can slightly bend against the walls of the outlet 21 of the container with a fluid 14, providing a goods sealing of the connection.

In one embodiment, the body 4 comprises the adapting means 7 in the form of an annular member providing a sealing between the body 4 and the container with a fluid 14. In the embodiment presented in FIG. 2 and FIG. 3, the body 4 comprises the adapting means 7 in the form of two annular members of a different diameter, allowing to adapt the diameter of the body 4 to the diameters of the outlets 21 of the containers with a fluid 14, wherein the annular member having a smaller diameter is arranged closer to the bottom 15 of the body 4.

In the embodiment shown in FIG. 1 and FIGS. 4 to 6, the body 4 comprises the adapting means 7 in the form of at least three annular members of a different diameter, allowing to adapt the diameter of the body 4 to the diameters of the outlets 21 of different containers with a fluid 14, wherein the annular member having the smallest diameter is arranged closest to the bottom 15 of the body 4, while each consecutive annular member has a bigger diameter than the previous one.

In yet another embodiment, the body 4 comprises the adapting means 7 in the form of a dense spiral arranged around the circumferential side wall 16, narrowing down toward the bottom 15, allowing to adapt the diameter of the body 4 to the diameters of the outlets 21 of the different containers with a fluid 14.

The above described method of mounting the body on the outlet 21 of the container with a fluid 14 allows to use the device 26 with a variety of standard and non-standard containers with a fluid. The adapting means 7 allow to mount the body 4 on outlets having different diameters and comprising protrusions on the inner walls so as to provide a very tight connection between the body 4 and the outlet 21 of the container with a fluid 14.

In the next stage, the core 18 of the container 1 is inserted through the opening 6 of the body 4 into the chamber 8 of the body 4 mounted on the outlet 21 of the container with a fluid 14 until the limiting means 22 of the container 1 rest on the top surface 5 of the body 4 to connect tightly the container 1 with the body 4 in a push-fit fashion. The container 1 also comprises the mounting means 23 placed during the mounting of the container 1 onto the body 4, in the inlet 12 of the pressure equalising means 9 to easily fit together the container 1 and the body 4. The limiting means 22 ensure positioning of the core 18 of the container 1 above the bottom 15 of the body 4 allowing operation of the umbrella gasket 13 mounted in the mounting slot 25. Owing to the limiting means 22, after push-fitting the core 18 of the container 1 in the chamber 8 of the body 4, the inflow 20 of the container 1 is positioned at a distance from the bottom 15 of the body 4. The distance of the inflow 20 of the container 1 from the bottom 15 of the body 4, allows the umbrella gasket 13 to swing aside during a suction movement performed by an individual requiring it. The swinging aside of the umbrella gasket 3 allows a fluid to flow from the container with a fluid 14 through the inflow means 1 into the chamber 8 of the body 4. The container 1 is connected with the body 4 such that the core 18 of the container 1 is push-fitted into the chamber 8 of the body 4. The chamber 8 of the body 4 is match to the core 18 of the container 1 in terms of its shape. The matching shapes of the chamber 8 of the body 4 and of the core 18 of the container 1 provides a tight connection between the core 18 of the container 1 and the chamber 8 of the body 4. The limiting means 22 provide an additional sealing by means of their overlapping the top surface 5 of the body 4 around the edge of the opening 6 of the body 4.

In one embodiment, the container 1 comprises an additional circumferential gasket (not shown), arranged between the limiting means 22 and the inflow 20 of the container 1, on the outer side of the core 18 of the container 1, around the circumference of the core 18 of the container 1. The circumferential gasket provides an additional sealing between the core 18 of the container 1 and the chamber 8 of the body 4 after push-fitting the core 18 of the container 1 into chamber 8 of the body 4.

Depending on the situation and the need, the stages of mounting of the body 4 to the outlet 21 of the container with a fluid 14 and the container 1 to the body 4 can be reversed. This means that the container 1 can be mounted onto the body 4 first, followed by mounting of the body 4 with the container 1 on the outlet 21 of the container with a fluid 14.

When the device 26 is connected to the container with a fluid 14, an individual requiring it taking a solid medicinal product or a dietary supplement 27, places the outflow 16 in the form of a mouthpiece of the container 1 in the mouth and tilts the container with a fluid 14. When the container with a fluid 14 is tilted, a solid medicinal product or dietary supplement 27 pours into the oral cavity of such an individual requiring it. Then, said individual requiring it, by means of a slight suction movement, sucks in the fluid from the container with a fluid 14. The flow of the fluid is controlled by the umbrella gasket 3 attached to the body 4 by means of the mounting slot 25. Upon making a suction movement, the umbrella gasket 3 swings away allowing a fluid to flow from the container with a fluid 14 through the inflow means 10 into the chamber 8 of the body 4 and then through the element 2 permeable to a fluid, the fluid enters the core 18, washing out the inside of the core 18 and then enters the oral cavity of an individual taking a solid medicinal product or a dietary supplement 27. When the suction movement is not performed, the umbrella gasket returns to the starting position, preventing the fluid from receding back to the container with a fluid 14. The fluid from the container with a fluid 14, together with a solid medicinal product or a dietary supplement 27, enters the oral cavity of an individual requiring it, wherein there is a risk of a solid medicinal product or a dietary supplement 27 being spat back into the core 18 of the container 1 in the form of a suspension and then entering in the form of a suspension into the chamber 8 of the body 4 through the element 2 permeable to a fluid. Owing to the umbrella gasket 3, said suspension is prevented from entering the container with a fluid 14. Hence, the umbrella gasket 3 is also provided as an additional protection, together with the element 3 permeable to a fluid, preventing a solid medicinal product or a dietary supplement 27 from entering the container with a fluid 14. Also, in the body 4 there is provided a pressure equalising gasket 13 for equalising the pressure in the container with a fluid 14. As an individual requiring it performs a suction movement, the pressure equalising gasket 13 swings away allowing air to flow into the container with a fluid 14 in order to equalise the pressure in the container with a fluid 14 thus facilitating the flow of a fluid, as described above. When the suction movement is not performed, the pressure equalising gasket 13 returns to the starting position, preventing the fluid from the container with a fluid 14 from flowing through the pressure equalising gasket 14.

After finishing taking of a solid medicinal product or a dietary supplement 27, the body 4 may be removed from the outlet 21 of the container with a fluid 14 by means of the flange member 17 facilitating removal of the body 4 from the outlet 21 of the container with a fluid 14. The flange member 17 provided in the body 4 serves also a stopper preventing the body 4 from being pushed into the outlet 21 of the container with a fluid 14 too deep.

In one embodiment, the body 4 comprises a flange member 17 shaped to accommodate fingers in order to facilitate the removal of the body 4 from the outlet 21 of the container with a fluid 14. In one embodiment, the body 4 comprises a flange member 17 in the form of two opposite protrusions facilitating the removal of the body 4 from the outlet 21 of the container with a fluid 14.

1. A body intended for being mounted to/on the outlet of a container with a fluid, adapted to receive a container for administering a solid medicinal product or a dietary supplement together with a fluid, wherein the body is elongated and the body comprises:
a bottom,
a circumferential side wall,
a top surface,
a chamber for placing therein the container for administering a medicinal product or a dietary supplement, wherein in the bottom of the body there are inflow means for providing inflow of the fluid from the container with a fluid into the chamber,
pressure equalising means in the container with a fluid,
wherein in the top surface there is an opening for placing therein the container,
wherein around the circumferential side wall of the body there are arranged adapting means having a diameter bigger than the diameter of the body for adapting the diameter of the body to the diameter of the outlet of the container with a fluid on which the body is mounted, and for sealing the connection between the body and the container with a fluid.

2. A body according to claim 1, wherein the body comprises a flange member arranged around the circumference of the body in the vicinity of the top surface.

3. A body according to claim 2, wherein the flange member is arranged at the level of the top surface.

4. A body according to claim 1, wherein the adapting means have the form of an annular member.

5. A body according to claim 1, wherein the adapting means have the form of two annular members having different diameters, wherein the annular member having a smaller diameter is arranged closer to the bottom of the body.

6. A body according to claim 1, further comprising adapting means in the form of three annular members having different diameters, wherein the annular member having the smallest diameter is arranged closest to the bottom of the body, while each next annular member has a bigger diameter than the previous one.

7. A body according to claim 1, wherein the inflow means comprise at least one opening for providing inflow of a fluid from the container and an element providing one-way flow of a fluid into the chamber.

8. A body according to claim 7, wherein the element providing one-way inflow of a fluid into the chamber is an umbrella gasket.

9. A body according to claim 1, wherein the body has a cylindrical shape.

10. A body according to claim 1, wherein the adapting means are inseparably connected to the body.

11. A body according to claim 1, wherein the adapting means are detachably connected to the body.

12. A container for administering a solid medicinal product or a dietary supplement together with a fluid, intended for being at least partly placed in the body for mounting to the container with a fluid, wherein
the container comprises a core comprising an inflow and an outflow, wherein the outflow is adapted for drinking therethrough, and the inflow is closed by an element permeable to a fluid and stoppable to a solid medicinal product or a dietary supplement, wherein the inside of the core is adapted for placing therein a medicinal product or a dietary supplement.

13. A container according to claim 12, further comprising limiting means for limiting the extent of placing the container into the chamber of the body.

14. A container according to claim 13, wherein the limiting means are a protrusion provided on at least a portion of the external circumference of the core.

15. A container according to claim 12, further comprising limiting means for mounting the container to the body.

16. A container according to claim 12, wherein the element letting a fluid pass through to the core is arranged on the inflow of the core.

17. A container according to claim 12, wherein the element letting a fluid pass through into the core (18) is arranged at the end of the core on the inflow side.

18. A container according to claim 12, wherein the element letting a fluid pass through to the core is arranged inside the core on the side of the inflow.

19. A container according to claim 12, wherein the element letting a fluid pass through to the core is a membrane.

20. A container according to claim 12, wherein the element letting a fluid pass through to the core is a mesh, preferably a polymer mesh.

21. A container according to claim 12, wherein the diameter of the core of the container, on at least a portion of its length, increases toward the outflow.

22. A container according to claim 12, wherein the container contains a solid medicinal product or a dietary supplement for taking together with a fluid.

23. A device for administering a solid medicinal product or a dietary supplement for taking together with a fluid, wherein
the device comprises a body for receiving a container containing a solid medicinal product or a dietary supplement for taking together with a fluid, as specified in claim 1, intended for mounting on the container with a fluid and
a container for administering a solid medicinal product or a dietary supplement for taking together with a fluid, intended for being at least partly placed in the body for mounting to the container with a fluid, the container comprises a core comprising an inflow and an outflow, wherein the outflow is adapted for drinking therethrough, and the inflow is closed by an element permeable to a fluid and stoppable to a solid medicinal product or a dietary supplement, wherein the inside of the core is adapted for placing therein a medicinal product or a dietary supplement.

24. A device for administering a solid medicinal product or a dietary supplement together with a fluid according to claim 23, wherein the device comprises an element providing one-way flow of a fluid into the chamber.

25. A device for administering a solid medicinal product or a dietary supplement together with a fluid according to claim 24, wherein the element providing one-way inflow of a fluid into the chamber is an umbrella gasket.

26. A device for administering a solid medicinal product or a dietary supplement together with a fluid according to claim 23, wherein the body is permanently connected to the container.

27. A device for administering a solid medicinal product or a dietary supplement together with a fluid according to claim 23, wherein the body is detachably connected to the container.

28. A device for administering a solid medicinal product or a dietary supplement together with a fluid according to claim 23, for administering of a medicinal product or a dietary supplement to an individual requiring it.

29. A device for administering a solid medicinal product or a dietary supplement together with a fluid according to claim 28, for administering a medicinal product or a dietary supplement to an individual requiring it, the individual being selected from a paediatric group.

30. A device for administering a solid medicinal product or a dietary supplement together with a fluid according to claim 28, for administering a medicinal product or a dietary supplement to an individual requiring it, the individual being selected from a geriatric group.

31. A device for administering a solid medicinal product or a dietary supplement together with a fluid according to claim 30, for administering a medicinal product or a dietary supplement to an individual requiring it, the individual being selected from a geriatric group with cardiology problems.
